(19) United States
(12) Patent Application Publication
(10) Pub. No.: US 2002/0016118 A1
(43) Pub. Date: Feb. 7, 2002

(54) High-strength lightweight composite fabric with low gas permeability

(76) Inventors: W. Neal Bebber, Matthews, NC (US); Charles A. Howland, Temple, NH (US); Gregory D. Williams, Matthews, NC (US)

Correspondence Address: SUMMA & ALLAN, P.A., 11610 NORTH COMMUNITY HOUSE ROAD, SUITE 200, CHARLOTTE, NC, 28277, US

(21) Appl. No.: 09/927,034

(22) Filed: Aug. 9, 2001

Related U.S. Application Data
(63) Continuation of application No. 09/371,474, filed on Aug. 10, 1999.

(51) Int. Cl. B32B 27/02; B32B 5/26; B32B 27/12

(52) U.S. Cl. 442/286; 442/181; 442/203; 442/218; 442/220; 442/239; 442/243; 442/255; 442/261; 442/287; 442/289; 442/291

(57) ABSTRACT

A laminate is disclosed for high strength, low weight gas enclosure applications such as aerostats or airships. The laminate is formed of at least one woven fabric layer with an aggregate strength greater than 10 grams per denier. The yarns in the fabric have sufficient twist to provide the desired tensile conversion but less than the amount of twist that would produce unsatisfactory flex fatigue. The fabric has a yarn to fabric strength ratio sufficient to impart tear resistance to the fabric, but less than the coarseness ratio at which flex fatigue performance is unsatisfactory, and the fabric has the minimal number of crossing points among the woven yarns that will impart sufficient integrity for the fabric to be manufactured into the laminate. A gas barrier material is then laminated to the fabric layer.

### FIELD OF THE INVENTION

The present invention relates to lighter-than-air vehicles such as airships, aerostats, blimps, and balloons, and in particular relates to an improved material for forming the hull or skin of such vehicles.

### BACKGROUND OF THE INVENTION

The present invention relates to lighter-than-air (LTA) vehicles. Although in layman's terms, they are often called blimps, the terminology can be more properly expressed using the following categories (among others). In this regard, the term “aerostat” is often used to describe a tethered lighter-than-air vehicle filled with a gas, with a hull fabricated from sheet material, and usually a stabilizing tail assembly that gives the vehicle aerodynamic stability. When a large LTA vehicle is formed that includes an internal structure of some sort, a plurality of internal gas bags and an on-board propulsion system, it is typically referred to as an “airship.” The term “dirigible” is also typically used to refer to this type of LTA vehicle. When the LTA vehicle is formed of a hull or balloon structure that requires no internal separation of gas bags, and which essentially is made up of a single chamber, it is more typically referred to as a “blimp.” As will be seen from the detailed description and claims that follow, the difference between and among these terms is not of particular significance to the present invention, and thus the terms can be used interchangeably for purposes of describing the invention, even though those with skill in this art recognize the particular differences in these terms.

An airship gains its lift from Archimedes' principle; i.e., the physical law by which objects immersed in a fluid are buoyed by a force equivalent to the weight of the displaced fluid. Because an aerostat does not gain its lift from the movement of air over an airfoil, but rather from the amount of air that it displaces with a lighter-than-air gas, the airships with the greatest lift on a proportional basis are those which weigh the least based on the volume of air that they displace.

For most practical purposes, some of the factors affecting the lift of an airship on a volume basis are generally fixed. For example, although molecular hydrogen (H₂) is the least dense gas (two grams per mole) available for filling airships, and thus the most efficient from a weight standpoint, it is highly explosive, must be handled very carefully, and presents a constant risk. Thus, hydrogen gas is generally less favored for commercial aerostats because of these issues. Helium (He) weighs four (4) grams per mole, and thus is proportionally twice as heavy as hydrogen. Because helium is an inert gas, however, it eliminates the flammability issue as well as many other chemical reaction problems that can occur with other gases. Accordingly, helium is the gas of choice for most airship applications. As a result, the fixed weight of a particular volume of a selected gas for an aerostat remains the same regardless of the construction of the aerostat. As known to those of even basic skill in chemistry, the weight of a given volume of a gas can be calculated to a useful degree of accuracy using fundamental relationships such as Avogadro's Law, and the ideal gas law.

Accordingly, the main factor in reducing the weight of an airship on a per volume basis is to reduce the weight of the other materials that go into the physical structure of the airship. Because the hull forms such a large part of an airship's physical structure, reducing the hull's weight on a per-unit basis remains a useful goal in this art.

First and foremost, however, the hull must provide an efficient gas barrier. Generally speaking, the hull material or skin of an airship should also provide the ideal combination of at least the following additional factors: flex fatigue (the resistance to failure under repeated bending loads), tensile strength (the ability to resist breaking under tension), slit tear resistance (the ability to resist rupture from tearing), adhesion (the degree to which surfaces are held together by interfacial forces), thickness, joint performance (i.e., joints between adjacent segments of material should be at least as strong as the material itself, and preferably stronger), predictable crimp (for fabric layers), and proper elongation under load (the degree to which a fabric will stretch at a specified load or at a breaking point).

In order to meet these various requirements, the hulls of more modern airships are conventionally formed of a multiple-layer material, usually in the form of a laminate in which the layers are fixed to one another either through mechanical or chemical adhesion, or through the use of filling or tie layers of polymeric materials that provide the desired gas barrier properties as well as the mechanical properties otherwise desired in the laminate. Perhaps a most typical recent laminate structure is set forth in U.S. Pat. No. 5,118,558 to named inventors Mater et al. The Mater structure is a series of layers of both polymer and fabric and film material laminated to one another in an attempt to provide the strength and fatigue characteristics desired while retaining the necessary gas barrier properties.

As used herein, the term “laminated fabric” represents a fabric composed of a high-strength reinforcing scrim or base fabric between two plies of flexible thermoplastic film. In most laminates of this type, the polymers on both faces of the fabric can, will, and indeed are intended to, flow through the interstices, and bond to the fabric.

As set forth in the Mater '558 patent, the laminate includes a base woven fabric (illustrated at 24 in the '558 patent) that provides much of the structural characteristics of the overall laminate.

In heavy load cargo airship applications, however, fabrics the same as or similar to the Mater '558 patent tend to form the woven fabric which is thick and bulky. If typical industrial polyester fiber is used the strength of the fiber and the demand of these large airships leads to a very large yarn of perhaps 6-10,000 denier. The alternates is to use high-strength synthetic materials such as aromatic polyamides, one example of which is available from DuPont under the Kevlar® trademark or liquid crystal polyester (e.g., Vectran®) in the form of highly twisted yarns in a plain woven structure (e.g., U.S. Pat. Nos. 5,837,623 and 5,565,264). Even if the fibers have tenacitys of 20 grams per denier the yarns required become thick and bulky with the typical twist levels. Because of these strength requirements for the hull material, the yarns, and thus the weave, are typically formed very thick. In turn, the amount of polymer used to fill in the weave in order to provide both adhesion and the gas barrier tends to be quite high. Stated differently, the use of big, bulky high-strength, high-twist yarns produces a relatively thick woven structure which requires a large amount of polymer (typically polyurethane) to seal it. As a result, the hull materials formed from bulky yarns, bulky weaves, and thick polyurethane coatings tend to have a weight of about 35 ounces per square yard. Although such a material is certainly “lightweight” in conventional terms, an airship of practical cargo or passenger carrying capability will include thousands of square yards of such material. For example, an airship or aerostat with 40,000 square yards of skin would include almost 88,000 pounds (almost 44 tons) of laminate material. Accordingly, reducing the weight of the hull material is one way to reduce the overall weight of the entire airship on a proportional basis. Nevertheless, given the safety requirements for both cargo and passengers that are required before a commercial airship can be put into use, the strength requirements for the hull material cannot be compromised.

Accordingly, a need exists for improved airship hull materials that maintain all of the physical requirements of conventional materials, but which weigh significantly less on a proportional basis.

### OBJECT AND SUMMARY OF THE INVENTION

Therefore, it is an object of the present invention to provide laminate structures for airship hull materials that provide all the gas barrier, strength, and other mechanical properties required of such material, but at a significantly lower weight on a proportional basis.

The invention meets this object with a laminate for high-strength, low-weight gas enclosure applications such as aerostats or airships. The laminate comprises at least one woven fabric layer with an aggregate strength greater than 10 grams per denier. The yarns and fabric have sufficient twist to provide the desired tensile conversion of the fiber, but less than the amount of twist that would produce an unsatisfactory, thick, heavy laminate. The fabric has a yarn-to-fabric strength ratio sufficient to impart tear resistance to the fabric, and the minimal number of crossing points among the woven yarns that will impart sufficient integrity for the fabric to be manufactured into the laminate; yet not reduce the tear performance of the fabric. One or more gas barrier materials are laminated to the fabric layer to complete the overall structure.

The foregoing and other objects and advantages of the invention and the manner in which the same are accomplished will become clearer based on the following detailed description taken in conjunction with the accompanying drawings in which:

### BRIEF DESCRIPTION OF THE DRAWINGS

FIG. 1 is an overall perspective view of an airship that can take advantage of the present invention;

FIG. 2 is a cutaway, partial cross-sectional view of a laminate according to the present invention;

FIG. 3 is a perspective view of the woven fabric of the laminate of the present invention;

FIG. 4 is a cross-sectional view of the laminate of the invention taken along lines 4-4 of FIG. 2;

FIG. 5 is a cross-sectional view of a prior art laminate material for airships;

FIG. 6 is a schematic plot of flex fatigue versus twist for fabrics used in airship laminates; and

FIGS. 7 and 8 are photomicrographs taken cross sectional along the laminate material of the present invention in a manner analogous to FIG. 4.

### DETAILED DESCRIPTION

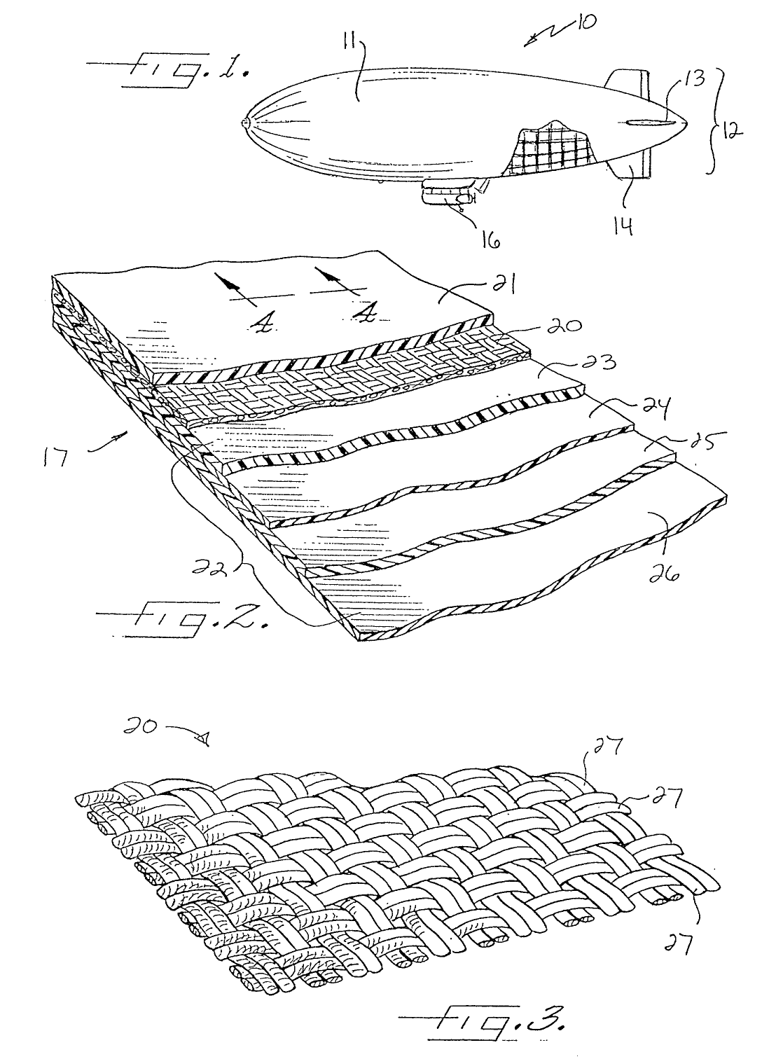

FIG. 1 is a perspective view of an airship generally designated at 10. As noted above, the airship 10 is also sometimes referred to as a “blimp,” “dirigible,” or “aerostat.” Each of these structures has the same features for the purposes of the present invention, and thus it will be understood that the invention applies to each type of airship, regardless of how it may be named in a particular application. Those of skill in this art will thus recognize that the invention is not limited to a particular classification of airship, but offers advantages regardless of the type of airship into which it may be incorporated.

As illustrated in FIG. 1, the airship 10 includes the gas envelope 11, and the tail assembly indicated by the brackets at 12. In most typical applications, the tail assembly 12 comprises both horizontal and vertical members 13 and 14 respectively. In aerostat applications in which the aerostat is tethered or otherwise maintained in a single position, the vertical and horizontal tail members 14 and 13 can be static. In applications for airships or blimps that are used in travel from place to place, the tail members 13 and 14 are typically tillable to provide additional aerodynamic control. These features are generally well known in the art and will not be discussed in detail herein as the invention is applicable to aerostats with either type of tail assembly.

FIG. 1 also indicates that in certain applications, the airship 10 can include an internal framework 15 that provides additional structural stability to the overall airship. Internal structures such as the structure 15 shown in FIG. 1 add a great deal of weight, however, and one of the advantages of the present invention is its capacity for forming a relatively large single gas envelope that has sufficient integrity to be used without such a framework and it thus provides significant weight advantages in many applications. In certain circumstances, the gas envelope 11 can be formed of a series of panels that are fixed together in an appropriate fashion to form the overall envelope 11. The panels can be welded together in a manner that provides integrity to the welds that are as strong or preferably stronger than the integrity of the gas envelope material itself. Stated differently, and this will be seen with respect to the present invention, the capability of the laminate to be welded should be such that the resulting welds are stronger than the fabric from which the welds are joined. Ideally, the fabric should fail in by breaking the fiber before the welds break.

The internal framework 15 is preferably formed of the most lightweight material capable of meeting the engineering requirements for the aerostat and is preferably selected from the group consisting of metals, polymers, composites formed of fibers and polymers, and combinations of these materials.

The airship 10 illustrated in FIG. 1 similarly can include a propulsion system designated as part of the gondola 16 suspended from the hull of the airship 10. Particular propulsion systems are well known in the art and will not be described in detail herein. In general, a conventional internal-combustion engine and propeller are preferred.

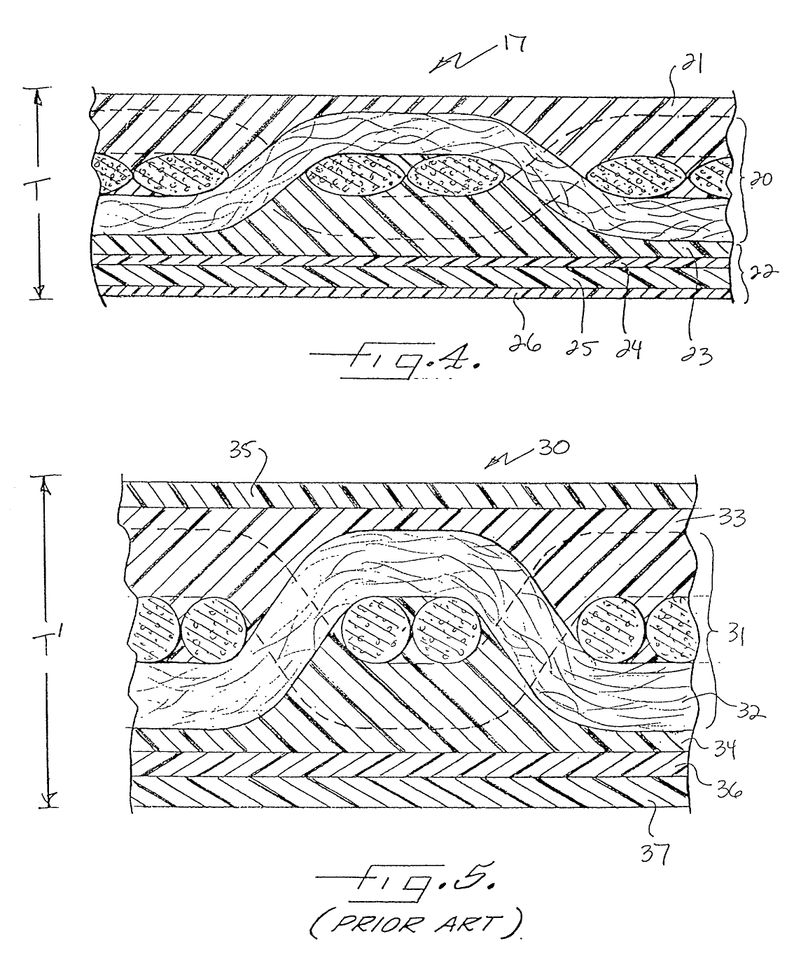

FIGS. 2 and 3 illustrate some of the primary features of the present invention. FIG. 2 is a cutaway perspective view of the laminate material broadly designated at 17 that forms the gas envelope 11 of an airship. In the view of FIG. 2, the upper portions of the laminate comprise the interior or “helium” side of the laminate, while the bottom portions form the outer or “weather” side of the laminate.

In the present invention, the laminate comprises at least one woven fabric layer 20 with an aggregate strength greater than ten grams per denier. Denier is used herein in its conventional sense; i.e., as a weight-per-unit-length measure of any linear material. In its most formal sense, denier is the weight in grams of 9,000 meters of the material; e.g., Hoechst Celanese Dictionary of Fiber & Textile Technology, Hoechst Celanese Corporation (1990); Tortora, Fairchild's Dictionary of Textiles, 7^{th} Ed., Capital Cities Media, Inc. (1996).

In fabrics according to the present invention, the strength per denier is taken in an aggregate sense and can represent that of the individual fibers, the yarn, the plies or the weave, provided that the strength requirement of ten grams per denier is met.

The yarns in the fabric of the present invention have sufficient twist to provide the desired textile conversion, but less than the amount of twist that would produce unsatisfactory thick and heavy fabric. Thus, in a numerical sense, using a 1500 denier yarn of 1.4 specific gravity, yarns of this description are considered to be “low twist” which is typically taken as being a twist of less than about 240 turns per meter, or less than six (6) turns per inch. Again using the 1500 denier example, twists of less than 118 turns per meter and less than three (3) turns per inch, and in some cases less than one (1) turn per inch, are most preferred. The helix angles achieved with this yarn represent the design factor. As in all twist calculations the twist must be adjusted based on denier to achieve a consistent helix angle.

The choice of twist should be as low as possible and still allow for realization of full tenacity of the yarn. As is well known, yarn tensile strength increases with some small amount of twist. This increase in tensile strength, however, begins to reverse itself at higher twist. A minimum twist level can be found for each material and yarn denier which gives the optimum tensile. Yarns at these twist levels are said to have high conversion efficiencies. In this regard, it has been unexpectedly discovered according to the present invention that lower twist yarns (lower helix angle) can provide the same or better flex fatigue as higher twist yarns, but at a much lower thickness and consequent weight on a proportional basis.

“Flex fatigue” is used herein to refer to the characteristics of the laminate with respect to bending stress loading. In this regard, its use is very similar, and perhaps identical depending upon the circumstances, to the use of the term “fatigue testing” with respect to metals and other materials. A material can fail (i.e., break or suffer irreversible degradation of tensile properties) after repeated stress loading even if the stress level never exceeds the fundamental strength limits of the material. The behavior of materials under repeated stress loading is typically evaluated by fatigue testing. In one form, a specimen is loaded repeatedly to a specific stress amplitude, and then the number of applications or repetitions of that stress that are required to cause failure is counted. Round specimens such as metal bars or rods are typically stress tested using rotational tests, but alternating deflection, or bending tests are more common for sheet materials such as the laminates of the present invention. When these large airship fabric assemblies are build, inflated and deflated the fabric is folded or bent on itself Those of ordinary skill in a number of arts are familiar with the concepts of bending flex fatigue and fatigue testing. A relatively straightforward exemplary discussion is given, for example, in Lindeburg, Engineer-in-Training Reference Manual, 8^{th} edition, Professional Publications, Inc. (1996) at pages 36-8 and 36-9.

With respect to the present invention, it has been conventionally understood that higher amounts of twist provide a greater resistance to bending flex fatigue; i.e., better bending flex fatigue performance. In conveyer and tire applications yarns are highly twisted for flex fatigue. Additional these high fatigue yarns are twisted in one direction and then plied together with twist in the other direction to make a larger corded structure.

As set forth in the background, however, greater twist in the yarns forming a fabric in a laminate cause the yarns to take on a round cross-section and to be form in to thicker fabrics which in turn makes them heavier on a per unit area basis. As further set forth in the background, in order to completely fill the void spaces in such a laminate and/or to provide an appropriate gas barrier to such thick fabrics, a relatively large amount of polymer material (typically polyurethane) must be applied as a coating to such fabrics. Thus, yarns with higher twist, while providing satisfactory flex fatigue performance, add weight in their own right on a proportional basis, and similarly require a proportionately larger amount of added polymer weight when coated.

Generally speaking, starting from no twist whatsoever, the flex fatigue performance of a fabric made from twisted yarns increases with the amount of twist. It has now been discovered, however, that in airship laminates according to the present invention, the relationship between flex fatigue and twist is bi-modal in its characteristics. FIG. 6 illustrates this in graphical fashion in which flex fatigue performance is plotted against twist. The results are shown in a general (rather than specific) pattern that has been observed in connection with the present invention. Thus, conventionally yarns have been twisted to the degree defined by the zone B in FIG. 6, which requires a higher degree of twist, and therefore a higher weight in the resulting laminate. The present invention, however, operates in the lower twist zone indicated at A in FIG. 6. It is expected that this zone has improved flex fatigue because the thinner structure keeps the more of the fiber near the low stress area in the bent laminate. As the yarns get rounder the fabric is thicker and the tensile and compressive stress on the inner and outer fiber go up rapidly. More stress for a given bending angle leads to greater strength loss per bending cycle and hence less flex performance. The conventional twist approach while improving the flex fatigue of the base yarns also subjects them to a more damaging condition because of increased thickness.

The tensile strength of the material in general refers to the strength shown by a specimen subjected to tension as distinct from torsion, compression, or shear. Dictionary of Fiber & Textile Technology, supra. The tensile strength is typically measured as the breaking force per unit width. The tensile strength is reduced into the tenacity or tensile strength per unit denier or conventional units of grams per denier, Fairchild's Dictionary of Textiles, supra. The tensile strength of fabrics, and tensile strength of the fabric of the invention, are typically measured in the direction of the warp or the filling by a tensile strength tester. Tensile strength is different from other types of measurement such as bursting strength or tear strength, although tear strength is important to the present invention.

In turn, tear strength, represents the ability of the material to resist rupture by tearing. Tear strength is measured by the force required to start or to continue a tear in a fabric under specified conditions. In the case of airship materials the specific tear geometery of importance is the slit tear. In testing, the material is subjected to a two-dimensional stress field. If the laminate is damaged in a collision, a slit or opening can be made in the laminate. The damage or slit in the material must not tend to grow under to stress field. If the slit grows the overall integrity of the airship could be put in question.

By using a fabric design which minimizes the number of crossing points the yarns can slide relative to one another. At the ends of a slit the stress field must break yarns to enlarge the damage. If the yarns are able to slide together they will tend to share the stress or load. In this way, the low crossing point designs give high slit tear performance.

In addition to improved slit tear, the low crossing point designs also reduce the thickness and weight of the laminate. In a plain weave or full knit the number of crossings is highest and the mobility of the yarns is lowest. In order for this structure to have high tear, the individual yarns must be proportionally larger. Because of larger yarns, the structure gets thicker. In preferred embodiments, the woven fabric has less than fifty percent (50%) of available crossing points formed, and in the most preferred embodiments, has less than twenty percent (20%) of available crossing points formed.

Adhesion represents the strength or state in which two surfaces are held together by interfacial forces, which in turn may consist of either valence forces or interlocking action, or both, Lewis, Hawley's Condensed Chemical Dictionary, 12^{th} Edition, Van Nostrand Reinhold (1993).

In the construction of airship laminates the assembly of sections of the ship are joined with various types of overlapping and taped joints. The details of these joints are not the subject of this patent, are generally well-understood in this art, and will not otherwise be discussed herein. In general, however, all of these joints subject the laminates to shear forces as inflation and service loads are transmitted across the joints. These loads must be carried by the adhesive strength of the bonds between the matrix and the fiber. This shear force performance is the result of at least two factors: first the correct chemical adhesion promotion between the matrix resins and the fibers must be present; second the fiber layers must have a structure that resists the pull out of one layer of loaded fibers from the other layers. The number of crossing points between the fiber layers is important in preventing the delamination or pull out of the structure in the joint area.

The term “crimp” is used herein in its ordinary sense; i.e., the waviness of a fiber or filament expressed as percentage crimp.. Crimp can also be expressed as the difference in distance between two points on an unstretched fiber and the same two points when the fiber is straightened under a specified tension. In such definitions, the crimp is expressed as a percentage of the unstretched length; Dictionary of Fiber & Textile Technology, supra.

The term “elongation” refers to the difference between the length of a stretched textile specimen and its initial length, expressed as a percentage of the initial length. It is measured at any specified load or at the breaking point; Fairchild's Dictionary of Textiles, supra.

Crossing points refer to any positions where yarns cross over one another. To be considered to be a crossing point the yarn must cross to the opposite side of the nearest yarn. These are also referred to in some circumstances as “locking points.” A plain weave or a full knit has the greatest number of crossing points, with other types of weaves or knits having progressively and proportionally fewer. When yarns or fibers have zero crossing points (for example, as in the Struble '530 patent noted above), the adhesive powers of the polymers in the laminate have to do all the work of holding the fabric together. In one sense, a lower number of crossing points per unit area tends to increase tear strength because it allows the filaments or fibers to slide together and resist tear, while the crossing or locking points tend to fix yarns in place where they must (and will) tear, rather than merely slide, at a specified load. From a theoretical standpoint, the fabric should have the fewest crossing points that still give the fabric sufficient integrity to allow the fabric to be handled and processed as the laminate is formed.

Accordingly, in another aspect, the invention is a laminate wherein the yarn-to-fabric strength ratio of the fabric is between about 1:36 and 1:8. As used herein the term “strength ratio” represents the ratio of the strength of a single fiber group to the strength of the fabric as a whole on a per unit basis. Because the range 1:36 to 1:8 represents a ratio, any appropriate and consistent measure of strength can be used. Tensile strength is one such appropriate measure, and in the case of the present invention, has been measured using a tensile testing machine setup to break both raveled strip fabric samples and single yarns samples. Tensile strength tests are well understood in the textile arts, and an appropriate one can be selected without undue experimentation. As one example, ASTM D2990 provides an appropriate measure of tensile strength.

In evaluating the strength ratio, it has been determined that strength ratios less than about 1:36 tend to represent fiber groups that are too small to give tear performance of the degree required in airship applications. At the other end of the range, it has been determined that for strength ratios greater than 1:8, the individual fiber groups are too large to give the desired materials weigh or flex fatigue performance.

Returning to FIG. 2, the gas barrier that is laminated to the fabric layer is formed of a plurality of layers of materials, typically polymers. It will be understood that the barrier layers described herein are quite useful with the fabric of the present invention, but that the advantages offered by the fabric 20 of the present invention are not limited to the particular number of barrier layers, nor to their particular chemical composition. As will be understood by those with skill in the art, prior to lamination the fabric may be coated or set with a small amount of polymer coating (usually polyurethane) sometimes combined with crosslinking chemistries (usually isocyanates) as necessary to improve processing and to achieve the required balance of physical properties in the final laminate.

As illustrated in FIG. 2, the airship laminate 17 includes a gas barrier formed of a first layer of polyurethane 21 on one face of the woven fabric layer. FIG. 2 illustrates the layer 21 as being on the helium side of the laminate 17. A second gas barrier layer, designated by the brackets 22, is formed of a plurality of layers of other materials. In the embodiment of FIG. 2, the second gas barrier layer 22 includes a layer of polyurethane 23 on the opposite side of the woven fabric 20 from the polyurethane layer 21. A layer of polyester film 24 is adjacent the polyurethane layer 23 and, among other uses, acts as a tie (i.e., adhesive) layer between the polyurethane layer 23 and the additional external layers of material. Another layer of polyurethane 25 is on the opposite face of the polyester layer 24 from the polyurethane layer 23. The weather side of the laminate 17 is preferably completed with a layer of a fluorocarbon polymer 26 which in preferred embodiment is a polyvinylfluoride, such as that available from DuPont under their Tedlar™ trademark.

For airship applications, the laminate should have a gas transmission rate (cm³-mm/24 h-m²-atm) of 30 or less for carbon dioxide (CO₂), 10 or less for oxygen (O₂), and 5 or less for nitrogen (N₂).

The polymers for the laminate (e.g., polyurethane, (commercially available conventionally, and for reasons of visibility and other purposes, the first gas barrier layer 21 is pigmented to a dark color, preferably black. The other polyurethane layer 23 that faces the woven fabric 20 is likewise pigmented black. Polyester layer 24 is typically unpigmented, while the outermost polyurethane layer 25 is pigmented black. The polyvinylfluoride layer 26 forming the exterior of the laminate 17 is pigmented white and thus forms the external appearance of the laminate.

As known by those of ordinary skill in this art, the white pigment on the weather side of the laminate provides a reflective surface that reduces heat absorption, and certain white pigments can also block ultraviolet (UV) radiation, which otherwise tends to degrade many types of polymers. The black pigment on the gas side of the laminate also provides certain advantages, and in particular the black color makes the task of finding pin holes much easier.

FIG. 3 is a partial perspective view of the woven fabric 20 according to the present invention. As noted above, there are a number of characteristics of the woven fabric that are provided or enhanced by the present invention. Thus, in a first aspect, the woven fabric layer 20 can be considered to comprise a sheet of yarns 27 formed of high-strength manufactured fibers. The high-strength manufactured fibers can be any one of a number of synthetic fibers, provided they have the necessary strength for the overall laminate requirements. Typically preferred materials for the yarns 27 include aromatic polyamide yarns, liquid crystal polyester yarns, and blends of these with each other or with other manufactured fibers of the required strength. As noted above, the woven fabric layer 20 preferably has an aggregate strength of at least 10 grams per denier.

In a preferred embodiment, the woven fabric comprises a basket weave, and in a more preferred embodiment includes a 2×2 basket weave, which is the embodiment illustrated in FIG. 3. As set forth above, the 2×2 weave minimizes the crossing points and thus increases the performance of the overall laminate 17 in the manner described. The fabric can optionally include “looper” or “tic” yarns (not shown) if desired in a particular fabric.

In a preferred embodiment, the woven fabric comprises a basket weave, and in a more preferred embodiment includes a 2×2 basket weave, which is the embodiment illustrated in FIG. 3. As set forth above, the 2×2 weave minimizes the crossing points and thus increases the performance of the overall laminate 17 in the manner described. In addition to having good tear and weight performance this 2×2 basket retains enough crossing points to have adequate joint shear strength.

It will be understood that one preferred embodiment of the laminate of the invention can be formed using one such fabric layer; the invention is not limited to a single fabric layer. Thus, to the extent appropriate based on weight and performance requirements, the laminate of the invention could comprise two or more fabric layers. The layered structure can be bonded with tie yarns and with appropriate additional polymer material to adhere them together. If desired, the additional fabric layers can be biased with respect to one another. The thread lines of each layer need not be a 90 degrees to each other. Given the stress field of the airship thread line directions may be at other angles such as 30, 45 or 120 degrees. In each case, however, the strength-to-weight advantages of the woven fabric of the invention will provide significant weight and performance advantages over any other laminate that includes the same number of fabric layers.

In another aspect of the invention, the fabric illustrated in FIG. 3 comprises yarns that have a cross-sectional height-to-width aspect ratio of between about 1:2 and 1:7. The term “cross-sectional aspect ratio” is used herein to distinguish the cross-sectional profile of the yarns 27 from their diameter-to-length aspect ratio which would, of course, be quite a different number and represent different physical characteristics; i.e., the overall length of the yarn compared to its diameter.

As noted earlier, the fabric 20 illustrated in FIG. 3 can be characterized as having an aggregate strength greater than 10 grams per denier with the woven fabric 20 being formed of twisted yarns 27, and with the twisted yarns 27 having a helix angle no greater than that of a 1500 denier yarn at six twists per inch. Those familiar with the manufacture of yarns from filaments or fibers will recognize, of course, that the low twist gives the flat profile—and resulting advantages—of the yarns that have been described herein both subjectively and objectively.

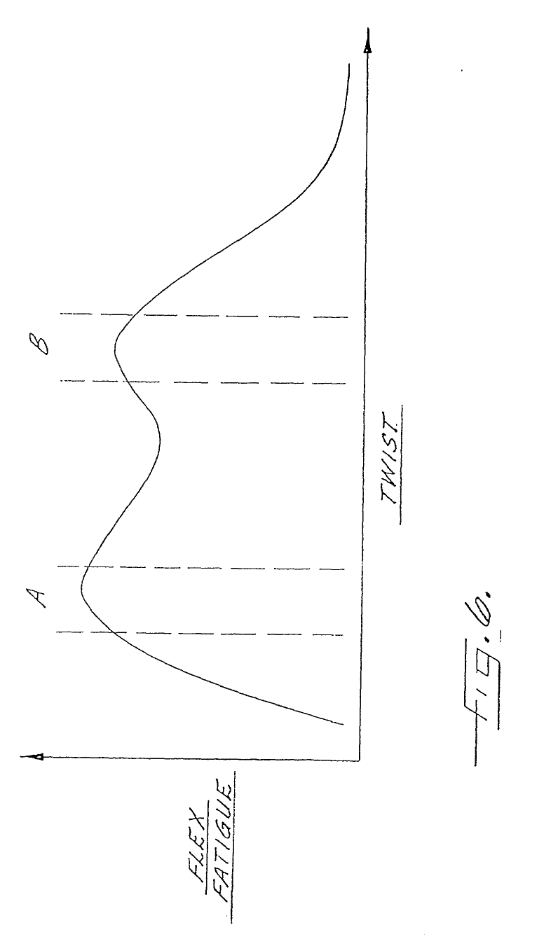

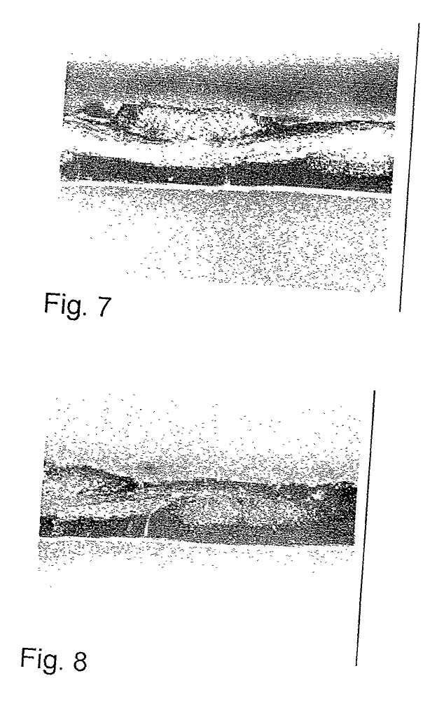

FIGS. 4 and 5 illustrate the differences between the laminate of the present invention and those of the prior art, including the advantages offered by the woven fabric 20 of the present invention. FIG. 4 shows the overall laminate broadly designated at 17 along with the individual polymer layers that make up the preferred embodiment. As in the embodiment illustrated in FIG. 2, of which FIG. 4 represents a cross section, the woven fabric is designated at 20, the first gas barrier layer at 21, and the second gas barrier layer at 22. In turn, the second gas barrier layer 22 is formed of the black pigmented polyurethane layer 23 immediately adjacent the woven fabric 20, the polyester tie layer 24 adjacent the black polyurethane layer 23, another layer of polyurethane 25 that is typically pigmented white, and the most external, weather facing side layer 26 formed of polyvinylfluoride.

As illustrated in FIG. 4, the woven fabric 20 has the flat yarns that have been previously described herein. Because the overall width profile of the yarns is more narrow than conventional yarns, the resulting overall profile of the woven fabric 20, and thus the overall thickness T can be minimized. Perhaps most importantly, the amount of polyurethane in the layers 21 and 23 that provide the integrity for the overall laminate can be somewhat minimized.

FIG. 5 is included herein as a representative view of a cross-sectional profile of prior art laminates for aerostat applications. The overall laminate is broadly designated at 30 and includes a woven fabric indicated by the brackets 31 that is formed of conventional round yarns 32 which are fully twisted from the desired high-strength fibers. Because these conventional yarns 32 are more fully twisted, they tend to be relatively bulky resulting in a relatively thick woven fabric 31. In turn, when the woven fabric 31 is coated with a polymer, again typically polyurethane, to form the respective layers 33 and 34, a much thicker, and thus heavier, layer of polymer or polyurethane must be applied to each side of the woven fabric 31. The laminate 30 of FIG. 5 also includes several additional interior and exterior layers which are designated for illustration purposes as an additional layer 35 on the polyurethane layer 33, and respective layers 36 and 37 on the opposite side of the fabric and laminated to polyurethane layer 34.

In practice the weight advantage as between the laminate of the invention of FIG. 4 and prior art as illustrated in FIG. 5 can be as much as 13 ounces per square yard. Thus, if a typical airship were to have approximately 40,000 square yards of material, the total weight savings would be more than 16 tons.

In the drawings and specification, there have been disclosed typical embodiments of the invention, and, although specific terms have been employed, they have been used in a generic and descriptive sense only and not for purposes of limitation, the scope of the invention being set forth in the following claims.

That which is claimed is:

1. A laminate for high strength, low weight gas enclosure applications such as aerostats or airships, said laminate comprising:
at least one woven fabric layer with an aggregate strength greater than 10 grams per denier;
with the yarns in said fabric having sufficient twist to provide the high tensile conversion but less than the amount of twist that would produce unsatisfactory flex fatigue;
a yarn to fabric strength ratio sufficient to impart tear resistance to the fabric, but less than the ratio at which flex fatigue performance is unsatisfactory;
said fabric having the minimal number of crossing points among the woven yarns that will impart sufficient integrity for the fabric to be manufactured into said laminate; and
a gas barrier material laminated to said fabric layer.

2. A laminate according to claim 1 wherein the strength ratio of said fabric is between about 1:36 and 1:8.

3. An airship laminate according to claim 1 wherein said yarns have a helix angle consistent with a twist of 6 turns per inch in a 1500 denier yarn.

4. An airship laminate according to claim 1 wherein said yarns have a helix angle consistent with a twist of 4 turns per inch in a 1500 denier yarn.

5. An airship laminate according to claim 1 wherein said yarns have a helix angle consistent with a twist of 2 turns per inch in a 1500 denier yarn.

6. An airship laminate according to claim 1 wherein said gas barrier comprises:
a first layer of polyurethane on one face of said woven fabric layer; and
a second gas barrier layer on the opposite face of said woven fabric, said second gas barrier layer comprising,
a layer of polyurethane on said fabric;
a layer of polyester film on said polyurethane layer;
another layer of polyurethane on said polyester layer; and
a layer of fluorocarbon polymer on said other polyurethane layer.

7. An airship laminate according to claim 1 wherein said yarns in said woven fabric are selected from the group consisting of aromatic polyamide yarns, liquid crystal polyester yarns, and blends thereof.

8. A laminate for high strength, low weight gas enclosure applications such as aerostats or airships, said laminate comprising:
at least one woven fabric layer with an aggregate strength greater than 10 grams per denier; and
at least a first gas barrier layer laminated to one face of said fabric layer;
said woven fabric layer comprising at least one sheet of yarns of high strength manufactured fibers.

9. An airship laminate according to claim 8 wherein said woven fabric layer has an aggregate strength of at least 10 grams per denier.

10. An airship laminate according to claim 8 and further comprising a second gas barrier layer laminated to the opposite face of said woven fabric from said first gas barrier layer.

11. An airship laminate according to claim 10 wherein said first gas barrier layer comprises a single layer of polymeric material and said second gas barrier layer comprises a plurality of polymeric layers.

12. An airship laminate according to Claim 11 wherein said first gas barrier layer comprises polyurethane.

13. An airship laminate according to claim 12 wherein said second gas barrier layer comprises:
a layer of polyurethane on said fabric;
a layer of polyester film on said polyurethane layer;
another layer of polyurethane on said polyester layer; and
a layer of fluorocarbon polymer on said other polyurethane layer.

14. An airship laminate according to claim 8 wherein said woven fabric comprises a basket weave.

15. An airship laminate according to claim 8 wherein said woven fabric comprises a two by two basket weave.

16. An airship laminate according to claim 8 wherein said woven fabric has less than 50% of available crossing points formed.

17. An airship laminate according to claim 8 wherein said woven fabric having less than 20% of available crossing points formed.

18. An airship laminate according to claim 8 comprising a plurality of fabric layers wherein each layer consists of at least one sheet of yarns.

19. An airship laminate according to claim 18 wherein said fabric layers are different from one another.

20. An airship laminate according to claim 8 wherein said yarns have a helix angle consistent with a twist of 6 turns per inch in a 1500 denier yarn.

21. An airship laminate according to claim 8 wherein said yarns have a helix angle consistent with a twist of 4 turns per inch in a 1500 denier yarn.

22. An airship laminate according to claim 8 wherein said yarns have a helix angle consistent with a twist of 2 turns per inch in a 1500 denier yarn.

23. An airship laminate according to claim 8 wherein said yarns have a height-to-width aspect ratio of between 1:2 and 1:7.

24. An airship laminate according to claim 8 wherein said woven fabric has a yarn to fabric strength ratio of between 1:36 and 1:8.

25. An airship laminate according to claim 8 wherein said yarns in said woven fabric are selected from the group consisting of aromatic polyamide yarns, liquid crystal polyester yarns, and blends thereof.

26. An airship comprising:
a gas envelope; and
a tail assembly;
said gas envelope comprising,
at least one woven fabric layer with an aggregate strength greater than 10 grams per denier;
with the yarns in said fabric having sufficient twist to provide the desired tensile conversion but less than the amount of twist that would produce unsatisfactory flex fatigue;
a yarn to fabric strength ratio sufficient to impart tear resistance to the fabric, but less than the coarseness ratio at which flex fatigue performance is unsatisfactory;
said fabric having the minimal number of crossing points among the woven yarns that will impart sufficient integrity for the fabric to be manufactured into said laminate; and
a gas barrier material laminated to said fabric layer.

27. An airship according to claim 26 wherein said gas envelope comprises a series of panels fixed together to form said envelope.

28. An airship according to claim 26 and further comprising an internal framework made of a rigid lightweight material.

29. An airship according to claim 26 wherein said lightweight material is selected from the group consisting of metals, polymers, composites formed of fibers and polymers, and combinations thereof.

30. An airship according to claim 26 and further comprising a propulsion system.

31. An airship according to claim 26 wherein said tail assembly comprises tiltable horizontal and vertical tail members.

32. An airship laminate according to claim 26 wherein said yarns have a helix angle consistent with a twist of 6 turns per inch in a 1500 denier yarn.

33. An airship laminate according to claim 26 wherein said yarns have a helix angle consistent with a twist of 4 turns per inch in a 1500 denier yarn.

34. An airship laminate according to claim 26 wherein said yarns have a helix angle consistent with a twist of 2 turns per inch in a 1500 denier yarn.

35. An airship according to claim 26 wherein said yarns have a height-to-width aspect ratio of between 1:2 and 1:7.

36. An airship according to claim 26 wherein said woven fabric has a yarn to fabric strength ratio of between 1:36 and 1:8.

37. An airship according to claim 26 wherein said first gas barrier layer comprises a single layer of polymeric material and said second gas barrier layer comprises a plurality of polymeric layers.

38. An airship according to claim 37 wherein said first gas barrier layer comprises polyurethane.

39. An aerostat according to claim 38 wherein said second gas barrier layer comprises:
a layer of polyurethane on said fabric;
a layer of polyester film on said polyurethane layer;
another layer of polyurethane on said polyester layer; and
a layer of fluorocarbon polymer on said other polyurethane layer.

40. An airship according to claim 26 wherein said yarns in said woven fabric are selected from the group consisting of aromatic polyamide yarns, liquid crystal polyester yarns, and blends thereof.

41. A laminate for high strength, low weight gas enclosure applications such as aerostats or airships, said laminate comprising:
at least one woven fabric layer with an aggregate strength greater than 10 grams per denier; and
a first gas barrier layer;
said woven fabric consisting essentially of yarns that have a cross-sectional height-to-width aspect ratio of between about 1:2 and 1:7.

42. An airship laminate according to claim 41 wherein said yarns have a helix angle consistent with a twist of 6 turns per inch in a 1500 denier yarn.

43. An airship laminate according to claim 41 wherein said yarns have a helix angle consistent with a twist of 4 turns per inch in a 1500 denier yarn.

44. An airship laminate according to claim 41 wherein said yarns have a helix angle consistent with a twist of 2 turns per inch in a 1500 denier yarn.

45. An airship laminate according to claim 41 wherein said woven fabric has a yarn to fabric strength ratio of between 1:36 and 1:8.

46. An airship laminate according to claim 41 and further comprising a second gas barrier layer laminated to the opposite face of said woven fabric from said first gas barrier layer.

47. An airship laminate according to claim 46 wherein said first gas barrier layer comprises a single layer of polymeric material and said second gas barrier layer comprises a plurality of polymeric layers.

48. An airship laminate according to claim 47 wherein said second gas barrier layer comprises:
a layer of polyurethane on said fabric;
a layer of polyester film on said polyurethane layer;
another layer of polyurethane on said polyester layer; and
a layer of fluorocarbon polymer on said other polyurethane layer.

49. An airship laminate according to claim 41 wherein said yarns in said woven fabric are selected from the group consisting of aromatic polyamide yarns, liquid crystal polyester yarns, and blends thereof.

50. A laminate for high strength, low weight gas enclosure applications such as aerostats or airships, said laminate comprising:
at least one woven fabric layer with an aggregate strength greater than 10 grams per denier; and
a first gas barrier layer;
said woven fabric being formed of yarns; and
said fabric having a yarn-to-fabric strength ratio of between about 1:36 and 1:8.

51. A laminate according to claim 50 wherein said yarns have a helix angle consistent with a twist of 6 turns per inch in a 1500 denier yarn.

52. A laminate according to claim 50 wherein said yarns have a helix angle consistent with a twist of 4 turns per inch in a 1500 denier yarn.

53. A laminate according to claim 50 wherein said yarns have a helix angle consistent with a twist of 2 turns per inch in a 1500 denier yarn.

54. A laminate according to claim 50 wherein said yarns have a height-to-width aspect ratio of between 1:2 and 1:7.

55. A laminate according to claim 50 and further comprising a second gas barrier layer laminated to the opposite face of said woven fabric from said first gas barrier layer.

56. A laminate according to claim 55 wherein said first gas barrier layer comprises a single layer of polymeric material and said second gas barrier layer comprises a plurality of polymeric layers.

57. A laminate according to claim 56 wherein said second gas barrier layer comprises:
a layer of polyurethane on said fabric;
a layer of polyester film on said polyurethane layer;
another layer of polyurethane on said polyester layer; and
a layer of fluorocarbon polymer on said other polyurethane layer.

58. A laminate according to claim 50 wherein said yarns in said woven fabric are selected from the group consisting of polyimide yarns, polyamide yarns, polyester yarns, and blends thereof.

59. A laminate for high strength, low weight gas enclosure applications such as aerostats or airships, said laminate comprising:
at least one woven fabric layer with an aggregate strength greater than 10 grams per denier; and
a first gas barrier layer;
said woven fabric being formed of twisted yarns; and
said yarns having no more than 6 twists per inch and a helix angle consistent with a 1500 denier yarn with between 2 and 6 turns per inch.

60. A laminate according to claim 59 in which said yarns have a helix angle consistent with the helix angle of a 1500 denier yarn that has between 2 and 6 turns per inch.

61. A laminate according to claim 59 wherein said yarns have a height-to-width aspect ratio of between 1:2 and 1:7.

62. A laminate according to claim 59 wherein said woven fabric has a yarn to fabric strength ratio of between 1:36 and 1:8.

63. A laminate according to claim 59 and further comprising a second gas barrier layer laminated to the opposite face of said woven fabric from said first gas barrier layer.

64. A laminate according to claim 63 wherein said first gas barrier layer comprises a single layer of polymeric material and said second gas barrier layer comprises a plurality of polymeric layers.

65. A laminate according to claim 64 wherein said second gas barrier layer comprises:
a layer of polyurethane on said fabric;
a layer of polyester film on said polyurethane layer;
another layer of polyurethane on said polyester layer; and
a layer of fluorocarbon polymer on said other polyurethane layer.

66. A laminate according to claim 59 wherein said yarns in said woven fabric are selected from the group consisting of polyimide yarns, polyamide yarns, polyester yarns, and blends thereof.
